(19) United States
(12) Patent Application Publication
(10) Pub. No.: US 2015/0286714 A1
(43) Pub. Date: Oct. 8, 2015

(54) Social Networking Music Application

(71) Applicant: Shawn David Talbott, Spanaway, WA (US)

(72) Inventor: Shawn David Talbott, Spanaway, WA (US)

(21) Appl. No.: 14/680,677

(22) Filed: Apr. 7, 2015

Related U.S. Application Data
(60) Provisional application No. 61/976,104, filed on Apr. 7, 2014.

(51) Int. Cl. G06F 17/30; G06Q 30/02; G06Q 50/00; H04L 12/58

(52) U.S. Cl. CPC G06F 17/30743; H04L 51/32; G06F 17/30882; G06Q 30/0269; G06Q 50/01

(57) ABSTRACT

A social networking music application for computers and mobile devices teaching a user interface/music player that connects a user's music to online social media websites and information to bring content to the user about the artist(s) that the user is listening to at the time and the ability to cross share that information with friends and family on social media. First, what artist and song a user is currently listening to is detected, then a connection is made to an online data base and finds the artist's online. Captures or links to the latest posts from these sites are posted/displayed to the user interface. Users can choose which social media website they wish to follow, choose if they want more information about the song, such as information about a guest artist on the track or producers to receive social media feeds from them as well.

### CROSS REFERENCE TO RELATED APPLICATIONS

This application claims priority from U.S. patent application Ser. No. 61/976,104, entitled “Social Networking Music Application”, filed on Apr. 7, 2014. The benefit under 35 USC §119(e) of the United States provisional application is hereby claimed, and the aforementioned application is hereby incorporated herein by reference.

### FEDERALLY SPONSORED RESEARCH

Not Applicable

### SEQUENCE LISTING OR PROGRAM

Not Applicable

### TECHNICAL FIELD OF THE INVENTION

The present invention relates generally to a mobile software application related to social media and music. More specifically, the present invention relates to a method, embodied on computer software executable by a machine, for providing and interconnecting social media software, news, and music applications.

### BACKGROUND OF THE INVENTION

Social media is generally defined as one or more Internet sites where people interact freely, sharing and discussing information about each other and their lives, using a multimedia mix of personal words, pictures, videos, and audio.

At these Web sites, individuals and groups create and exchange content and engage in person-to-person conversations. They appear in many forms including blogs and microblogs, forums and message boards, social networks, wikis, virtual worlds, social bookmarking, tagging and news, writing communities, digital storytelling and scrapbooking, and data, content, image and video sharing, podcast portals, and collective intelligence.

As social platforms have evolved, so have ways of sharing multimedia. Many applications teach great ways to stream music based on a similar artist or song you might already like. Other applications have this capability as well, but also allow users to add specific songs to their streaming playlist. While these are both ways of playing music at a party, the social interaction is fairly limited.

While these sites have been great for individual enjoyment, music is very much a social experience. People like to share their taste in music, go to concerts with others, and share news and information about artists or bands. People naturally want to share their music interests with one another, and there are increasingly more ways for users to do exactly that, but the prior art has yet to teach a method for combining the two in new and useful manner.

### Definitions

“Application software” is a set of one or more programs designed to carry out operations for a specific application. Application software cannot run on itself but is dependent on system software to execute. Examples of application software include MS Word, MS Excel, a console game, a library management system, a spreadsheet system etc. The term is used to distinguish such software from another type of computer program referred to as system software, which manages and integrates a computer's capabilities but does not directly perform tasks that benefit the user. The system software serves the application, which in turn serves the user.

The term “app” is a shortening of the term “application software”. It has become very popular and in 2010 was listed as “Word of the Year” by the American Dialect Society

“Apps” are usually available through application distribution platforms, which began appearing in 2008 and are typically operated by the owner of the mobile operating system. Some apps are free, while others must be bought. Usually, they are downloaded from the platform to a target device, but sometimes they can be downloaded to laptops or desktop computers.

“Electronic Mobile Device” is defined as any computer, phone, smartphone, tablet, or computing device that is comprised of a battery, display, circuit board, and processor that is capable of processing or executing software. Examples of electronic mobile devices are smartphones, laptop computers, and table PCs.

“GUI”. In computing, a graphical user interface (GUI) sometimes pronounced “gooey” (or “gee-you-eye”)) is a type of interface that allows users to interact with electronic devices through graphical icons and visual indicators such as secondary notation, as opposed to text-based interfaces, typed command labels or text navigation. GUIs were introduced in reaction to the perceived steep learning curve of command-line interfaces (CLIs), which require commands to be typed on the keyboard.

A “mobile app” is a computer program designed to run on smartphones, tablet computers and other mobile devices, which the Applicant/Inventor refers to generically as “a computing device”, which is not intended to be all inclusive of all computers and mobile devices that are capable of executing software applications.

A “software module” is a file that contains instructions. “Module” implies a single executable file that is only a part of the application, such as a DLL. When referring to an entire program, the terms “application” and “software program” are typically used.

A “software application module” is a program or group of programs designed for end users that contains one or more files that contains instructions to be executed by a computer or other equivalent device.

A “smartphone” (or smart phone) is a mobile phone with more advanced computing capability and connectivity than basic feature phones. Smartphones typically include the features of a phone with those of another popular consumer device, such as a personal digital assistant, a media player, a digital camera, and/or a GPS navigation unit. Later smartphones include all of those plus the features of a touchscreen computer, including web browsing, wideband network radio (e.g. LTE), Wi-Fi, 3rd-party apps, motion sensor and mobile payment.

“Swipe” is a command used primarily with touchscreen devices, such as smartphones and tablets. It is also supported by some laptops with trackpads and desktop computers with trackpad input. A “swipe” involves quickly moving (or “swiping”) your finger across a touchscreen or trackpad. For example, swiping the screen from right to left in a photo viewing application typically displays the next photo. While browsing multiple photos, swiping up or down may allow you scroll through the photo library. Most smartphones also allow you to swipe left or right to switch between home screens. Devices that support multi-touch may allow you to swipe with multiple fingers to perform different functions. In the present invention, the Applicant/Inventor uses the phrase “gesture swipe” interchangeable with “swipe”.

A “User” is any person registered to use the computer system executing the method of the present invention.

A “web application” or “web app” is any application software that runs in a web browser and is created in a browser-supported programming language (such as the combination of JavaScript, HTML and CSS) and relies on a web browser to render the application.

### SUMMARY OF THE INVENTION

The present invention is a social networking music application for computers and mobile devices. The present invention is a user interface/music player that connects a user's music to online social media websites (like FACEBOOK, TWITTER, IG, RSS, and more) and information to bring content to the user about the artist(s) that the user is listening to at the time. Also, the present invention provides the ability to cross share that information with friends and family on social media.

The present invention detects what artist and song a user is currently listening to, then connects to the present invention's online data base and finds the artist's online profile's. The present invention then captures or links the latest post from these sites and posts/displays them to the user interface for the user to enjoy. The user does not need to have social networking accounts to get information about their favor artist.

If the user has a social network account and sees a post they want to share with their friends, the click on it and then repost it to their choice of social media for their friends and family to see. Users can share their playlist with the public, friends, or keep it private. Users can choose which social media website they wish to follow, choose if they want more information about the song, such as information about a guest artist on the track or producers to receive social media feeds from them as well.

### BRIEF DESCRIPTION OF THE DRAWINGS

The accompanying drawings, which are incorporated herein form a part of the specification, illustrate the present invention and, together with the description, further serve to explain the principles of the invention and to enable a person skilled in the pertinent art to make and use the invention.

FIG. 1 is a flow chart illustrating the method of one embodiment of the present invention.

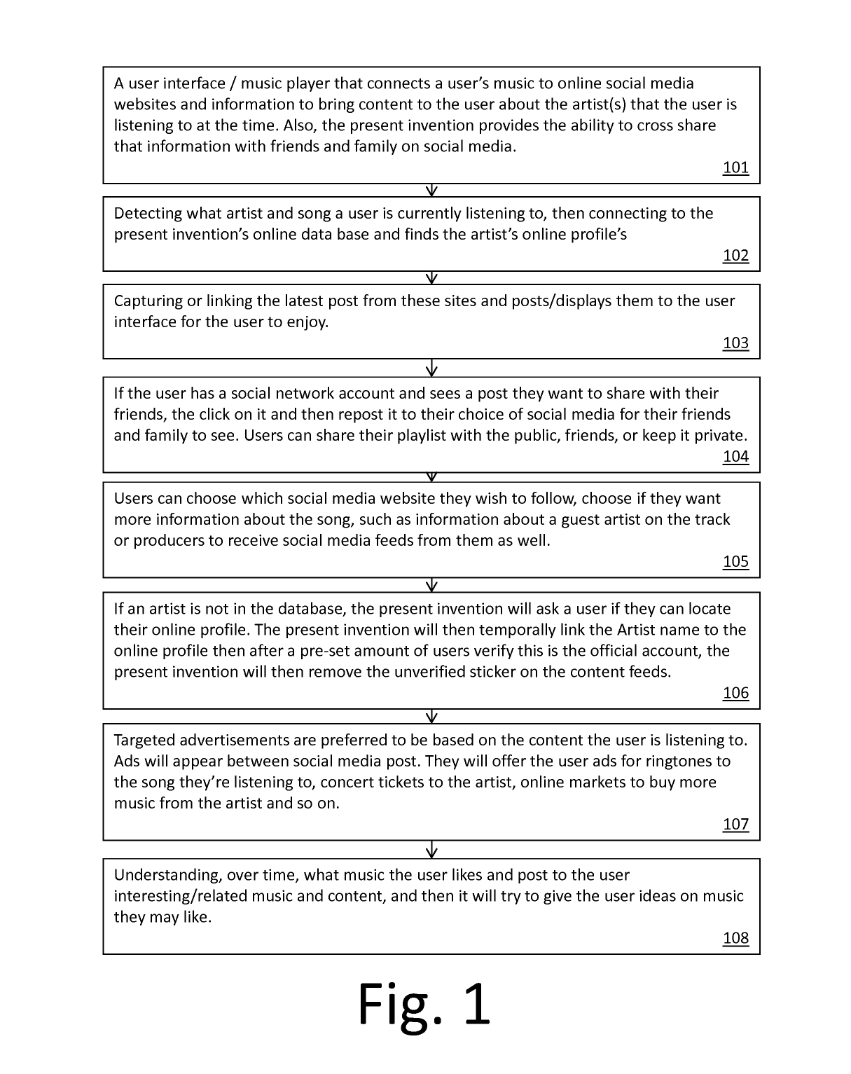

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

The present invention is a social networking music application for computers and mobile devices. The present invention is a user interface/music player that connects a user's music to online social media websites and information to bring content to the user about the artist(s) that the user is listening to at the time. Also, the present invention provides the ability to cross share that information with friends and family on social media in step 101.

The present invention detects what artist and song a user is currently listening to, then connects to the present invention's online data base and finds the artist's online profile's in step 102. For example, Entertainer's name: Rick Ross his twitter profile name is: “rickyrozay” Facebook is “OfficialRickRossFans” and so on. The present invention then captures or links the latest post from these sites and posts/displays them to the user interface for the user to enjoy. The user does not need to have social networking accounts to get information about their favor artist in step 103.

If the user has a social network account and sees a post they want to share with their friends, the user clicks on it and then reposts it to their choice of social media for their friends and family to see. Users can share their playlist with the public, friends, or keep it private in step 104. Users can choose which social media website they wish to follow, choose if they want more information about the song, such as information about a guest artist on the track or producers to receive social media feeds from them as well in step 105.

If an artist is not in the database, the present invention will ask a user if they can locate their online profile. The present invention will then temporally link the Artist name to the online profile then after a pre-set amount of users verify this is the official account, the present invention will then remove the unverified sticker on the content feeds in step 106.

Targeted advertisements are preferred to be based on the content the user is listening to. Ads will appear between social media post. They will offer the user ads for ringtones to the song they're listening to, concert tickets to the artist, online markets to buy more music from the artist and so on in step 107. The present invention will, overtime, understand what music the user likes and post to the user interesting/related music and content, and then it will try to give the user ideas on music they may like in step 108.

Artist/Promoters/Labels will be able to open special accounts to help drive Ads for artists and provide quantity ads. For example if an artist is doing a tour and they will be in Seattle in three weeks and tickets are available at Ticketmaster it will give a user who likes the music and is located in the area the ad. In another example, if a new album is coming out for the artist a user is listening to on iTunes next week; they will get an ad to pre-buy. Artist will be able to sell promotional products like t-shirt's and other items as well through the application of the present invention.

In alternative embodiments, the method would be powered by GOOGLE music or something similar to move the delivery and implementation of the present invention to more of a User Interface than a music player because of poor media tags from ripped music or to partner or develop powerful media retagging software.

The method taught by the present invention is set to run and/or executed on one or more computing devices. A computing device on which the present invention can run would be comprised of a CPU, hard disk drive, keyboard or other input means, monitor or other display means, CPU main memory or cloud memory, and a portion of main memory where the system resides and executes. Any general-purpose computer, tablet, smartphone, or equivalent device with an appropriate amount of storage space, display, and input is suitable for this purpose. Computer devices like this are well known in the art and are not pertinent to the invention.

In an alternative embodiment, the method of the present invention can also be written or fixed in a number of different computer languages and run on a number of different operating systems and platforms.

In yet another alternative embodiment, content from local or internet radio can be integrated. For example local radio stations can open an account to stream there music over/through the system of the present invention to provide the same experience. In another example, a TV show such as American Idol could to a promotional station through an implementation of the present invention with their artists and utilize the experience and benefits of the system and method of the present invention as well.

Although the present invention has been described in considerable detail with reference to certain preferred versions thereof, other versions are possible. Therefore, the point and scope of the appended claims should not be limited to the description of the preferred versions contained herein.

As to a further discussion of the manner of usage and operation of the present invention, the same should be apparent from the above description. Accordingly, no further discussion relating to the manner of usage and operation will be provided.

With respect to the above description, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention.

Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A method for providing a social networking music application executable by a machine and rendered on the display of the machine, comprising the steps of:
detecting what artist and song a user is currently listening to;
connecting to an online data base;
finding the artist's online profile's;
capturing or linking the latest post from these sites;
posting/displaying them to the user interface.

2. The method of claim 1, wherein if the user has a social network account and sees a post they want to share with their friends,
selecting a post;
reposting the post to their choice of social media.

3. The method of claim 1, further comprising the step of:
sharing a playlist with the public, friends, or keeping the playlist private.

4. The method of claim 1, further comprising the steps of:
Choosing which social media website to follow; and
choosing more information about a song.

5. The method of claim 4, wherein more information about a song includes:
information about a guest artist on the track,
producers, and
social media feeds.

6. The method of claim 1, wherein if an artist is not in the database, comprising the following additional steps:
asking a user if they can locate their online profile;
temporally linking the Artist name to the online profile;
creating a unverified sticker on the content feed;
collecting user verification;
removing the unverified sticker on the content feeds after a pre-set amount of users verify it is the official account.

7. The method of claim 1, wherein Targeted advertisements are preferred to be based on the content the user is listening to, comprising the following additional steps:
displaying ads between social media post;
offering the user ads for ringtones to the song they're listening to, concert tickets to the artist, and online markets to buy more music from the artist.

8. The method of claim 1, further comprising the step of:
understanding what music the user likes and post to the user interesting/related music and content; and
providing the user ideas on music they may like.

9. The method of claim 1, further comprising the step of:
Providing Artist/Promoters/Labels special accounts to help drive Ads for artists and provide quantity ads.
